(19) United States
(12) Patent Application Publication
(10) Pub. No.: US 2016/0337086 A1
(43) Pub. Date: Nov. 17, 2016

(54) METHOD FOR CONFIGURING PHYSICAL UPLINK CHANNEL, BASE STATION AND USER EQUIPMENT

(71) Applicant: SHARP KABUSHIKI KAISHA, Sakai City, Osaka (JP)

(72) Inventors: Xingya SHEN, Shanghai (CN); Renmao LIU, Shanghai (CN)

(73) Assignee: SHARP KABUSHIKI KAISHA, Sakai City, Osaka (JP)

(21) Appl. No.: 15/112,732

(22) PCT Filed: Jan. 22, 2015
(86) PCT No.: PCT/CN2015/071305

§ 371 Date: Jul. 20, 2016

(30) Foreign Application Priority Data
Jan. 23, 2014 (CN) 201410032297.X

(51) Int. Cl. H04L 1/18; H04W 4/00; H04W 76/04; H04W 72/04; H04L 5/00

(52) U.S. Cl. CPC H04L 1/18; H04W 72/0406; H04L 5/0055; H04W 76/046; H04W 4/005; H04W 88/08

(57) ABSTRACT

The present disclosure provides a method performed by a base station, comprising: determining whether repetitive transmission of a Hybrid Automatic Repeat reQuest (HARQ)-Acknowledgement (ACK) is enabled; determining whether Physical Downlink Control Channel (PDCCH)/Extended Physical Downlink Control Channel (EPDCCH), or Physical Downlink Shared Channel (PDSCH) is configured for repetitive transmission; and configuring for a User Equipment (UE) a Physical Uplink Control Channel (PUCCH) resource for transmission of the HARQ-ACK. A method performed by a UE, a corresponding base station and a corresponding UE are also provided. With the present disclosure, it is possible to improve resource utilization and spectrum/energy efficiency of MTC UEs supported by the LTE and reduce inter-cell time/frequency resource collisions.

### TECHNICAL FIELD

The present disclosure relates to wireless communication technology, and more particularly, to a method for configuring a physical uplink channel, a base station and a user equipment.

### BACKGROUND

The Long Term Evolution (LTE) system deployed by the 3^{rd} Generation Partner Project (3GPP) is intended to provide increasingly diversified mobile communication services in the future. Wireless cellular communications have become an essential part of people's lives and work. In the first release (Release 8) of the 3GPP LTE, Orthogonal Frequency Division Multiple Access (OFDMA) and Multiple Input Multiple Output (MIMO) techniques have been introduced. After evaluation and test by International Telecommunication Union (ITU), the 3GPP Release 10 has been established as the 4^{th} generation global mobile communication standard, known as LTE-Advanced. In the LTE-Advanced standard, Carrier Aggregation (CA) and relay techniques have been introduced to improve uplink (UL)/downlink (DL) MIMO technique while supporting heterogeneous network (HetNet) deployment.

In order to meet the market demand on home device communications and the deployment of a huge-scale Internet of Things (loT) in the future, the 3GPP has decided to introduce a low-cost Machine Type Communication (MTC) technique in the LTE and its further evolution, to transfer MTC services from the current GSM network to the LTE network and define a new type of User Equipment (UE), referred to as Low-cost MTC UE. Such UE can support MTC services in all duplex modes in the current LTE network and has: 1) one single receiving antenna; 2) a maximum Transport Block Size (TBS) of 1000 bits in UL/DL; and 3) a reduced baseband bandwidth of DL data channel of 1.4 MHz, a bandwidth of DL control channel identical to the system bandwidth of the network layer, and the same UL channel bandwidth and DL Radio Frequency (RF) part as UEs in the current LTE network.

The MTC is a data communication service without human involvement. A large-scale deployment of MTC UEs can be applied to various fields such as security, tracking, payment, measurement, consumer electronics, and in particular to applications such as video surveillance, supply chain tracking, intelligent metering and remote monitoring. The MTC requires low power consumption and supports low data transmission rate and low mobility. Currently, the LTE system is mainly designed for Human-to-Human (H2H) communication services. Hence, in order to achieve the scale benefit and application prospect of the MTC services, it is important for the LTE network to support the low-cost MTC devices to operate at low cost.

Some MTC devices are mounted in basements of residential buildings or locations protected by insulating films, metal windows or thick walls of traditional buildings. These devices will suffer significantly higher penetration loss in air interface than conventional device terminals, such as mobile phones and tablets, in the LTE network. The 3GGP has started researches on solution designs and performance evaluations for the LTE network to provide the MTC devices with a 20 dB of additional coverage enhancement. It is to be noted that an MTC device located in an area with poor network coverage has a very low data transmission rate, a very loose delay requirement and a limited mobility. For these MTC characteristics, some signaling and/or channels of the LTE network can be further optimized to support the MTC. The 3GPP requires providing the newly defined low cost UEs and other UEs running MTC services (e.g., with very loose delay requirements) with a certain level of LTE network coverage enhancement. In particular, a 15 dB of network coverage enhancement is provided in the LTE Frequency Division Duplex (FDD) network. Additionally, not all UEs running MTC services need the same network coverage enhancement.

In the 3GPP RAN #64 meetings in June, 2014, a new work item for Rel-13 has been proposed for the low complexity and enhanced coverage MTC (see non-patent document: RP-140990, New Work Item on Even Lower Complexity and Enhanced Coverage LTE UE for MTC, Ericsson, NSN). In the description of this work item, the LTE Rel-13 system shall allow MTC UEs supporting 1.4 MHz RF bandwidth in UL/DL (referred to as narrowband MTC UE) to operate over any system bandwidth (e.g., 1.4 MHz, 3 MHz, 5 MHz, 10 MHz, 15 MHz, 20 MHz, etc.) and provide the coverage enhancement function for such MTC UEs. In the system design, a uniform design is required for both low-cost MTC UEs and coverage enhanced MTC UEs. One of the major objects of this work item is to reduce the power consumption of the MTC UEs.

For 3GPP LTE UEs running MTC services in the coverage enhancement mode, the design and configuration of coverage enhancement for physical channels (such as EPDCCH/PDSCH/PUCCH/PUSCH) need to be standardized. According to the discussions in the 3GPP RANI #74 meeting, after completion of the initial access, the configuration mode of any physical channel that requires repetitive transmission is decided at the base station. In the discussions in the 3GPP RANI #75 meeting, for an MTC UE in the coverage enhancement mode, repetitive transmission of ACK/NACK on PUCCH is supported; whereas for a low-cost MTC UE having only one antenna, its transmission power may be reduced for power saving. Hence, unlike conventional UEs, MTC UEs require coverage enhanced physical uplink channels and retransmission of ACK/NACK over PUCCH. However, the PUCCH resources occupied by the repetitive transmission of ACK/NACK for these MTC UEs may conflict with the PUCCH resources occupied by conventional UEs. There is a need for re-standardization to solve the problem of PUCCH resource conflict and the problem of resource utilization.

Further, when a UE in the coverage enhancement mode runs an MTC application service, the EPDCCH/PDSCH/PUCCH/PUSCH requires repetitive transmission in a number of subframes. There is also a need for re-standardization for channel timing.

### SUMMARY

In order to solve the above problems, the present disclosure provides a method for configuring physical uplink control channel resources for a UE (a low cost UE or another UE that supports delay-tolerant MTC services and require a certain amount of coverage enhancement), and a base station and a UE.

In particular, in an aspect of the present disclosure, a method performed by a base station is provided. The method comprises: determining whether repetitive transmission of a Hybrid Automatic Repeat reQuest (HARQ)-Acknowledgement (ACK) is enabled; determining whether Physical Downlink Control Channel (PDCCH)/Extended Physical Downlink Control Channel (EPDCCH), or Physical Downlink Shared Channel (PDSCH) is configured for repetitive transmission; and configuring for a User Equipment (UE) a Physical Uplink Control Channel (PUCCH) resource for transmission of the HARQ-ACK.

In an embodiment, when the repetitive transmission of the HARQ-ACK is enabled: the PUCCH resource for transmission of the HARQ-ACK is configured for the UE via an index of a Control Channel Element (CCE) of PDCCH or an index of a CCE of EPDCCH when neither of PDCCH/EPDCCH and PDSCH is configured for repetitive transmission; and the PUCCH resource for transmission of the HARQ-ACK is configured for the UE via Radio Resource Control (RRC) signaling when PDCCH/EPDCCH or PDSCH is configured for repetitive transmission.

In an embodiment, when the repetitive transmission of the HARQ-ACK is not enabled and PDCCH/EPDCCH or PDSCH is configured for repetitive transmission, the PUCCH resource for transmission of the HARQ-ACK is configured for the UE via Radio Resource Control (RRC) signaling.

In an embodiment, a set of PUCCH resources is configured for the UE via Radio Resource Control (RRC) signaling and PDCCH/EPDCCH indicates over which of the set of PUCCH resources should the UE transmit HARQ-ACK.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, a scheme for repetitive transmission of HARQ-ACK by the UE is configured via RRC signaling or corresponding PDCCH control information.

In an embodiment, the scheme for repetitive transmission of HARQ-ACK by the UE comprises a scheme in PUCCH Format 3.

In another aspect of the present disclosure, a method performed by a base station is provided. The method comprises: determining whether Physical Downlink Control Channel (PDCCH)/Extended Physical Downlink Control Channel (EPDCCH), or Physical Downlink Shared Channel (PDSCH) is configured for repetitive transmission; and configuring for a User Equipment (UE) a Physical Uplink Control Channel (PUCCH) resource for transmission of a Hybrid Automatic Repeat reQuest (HARQ)-Acknowledgement (ACK).

In an embodiment, the PUCCH resource for transmission of the HARQ-ACK is configured for the UE via an index of a Control Channel Element (CCE) of PDCCH or an index of a CCE of EPDCCH when neither of PDCCH/EPDCCH and PDSCH is configured for repetitive transmission; and the PUCCH resource for transmission of the HARQ-ACK is configured for the UE via Radio Resource Control (RRC) signaling when PDCCH/EPDCCH or PDSCH is configured for repetitive transmission.

In an embodiment, a set of PUCCH resources is configured for the UE via Radio Resource Control (RRC) signaling and PDCCH/EPDCCH indicates over which of the set of PUCCH resources should the UE transmit HARQ-ACK.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, a scheme for repetitive transmission of HARQ-ACK by the UE is configured via RRC signaling or corresponding PDCCH control information.

In an embodiment, the scheme for repetitive transmission of HARQ-ACK by the UE comprises a scheme in PUCCH Format 3.

In another aspect of the present disclosure, a method performed by a User Equipment (UE) is provided. The method comprises: determining whether repetitive transmission of a Hybrid Automatic Repeat reQuest (HARQ)-Acknowledgement (ACK) is enabled; determining whether Physical Downlink Control Channel (PDCCH)/Extended Physical Downlink Control Channel (EPDCCH), or Physical Downlink Shared Channel (PDSCH) is configured for repetitive transmission; and transmitting the HARQ-ACK over a Physical Uplink Control Channel (PUCCH) resource allocated by a base station.

In an embodiment, when the repetitive transmission of the HARQ-ACK is enabled: the PUCCH resource for transmission of the HARQ-ACK is obtained via an index of a Control Channel Element (CCE) of PDCCH or an index of a CCE of EPDCCH when neither of PDCCH/EPDCCH and PDSCH is configured for repetitive transmission; and the PUCCH resource for transmission of the HARQ-ACK is obtained via Radio Resource Control (RRC) signaling when PDCCH/EPDCCH or PDSCH is configured for repetitive transmission.

In an embodiment, when the repetitive transmission of the HARQ-ACK is not enabled and PDCCH/EPDCCH or PDSCH is configured for repetitive transmission, the PUCCH resource for transmission of the HARQ-ACK is obtained via Radio Resource Control (RRC) signaling.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.

In another aspect of the present disclosure, a method performed by a User Equipment (UE) is provided. The UE comprises: determining whether Physical Downlink Control Channel (PDCCH)/Extended Physical Downlink Control Channel (EPDCCH), or Physical Downlink Shared Channel (PDSCH) is configured for repetitive transmission; and transmitting a Hybrid Automatic Repeat reQuest (HARQ)-Acknowledgement (ACK) over a Physical Uplink Control Channel (PUCCH) resource allocated by a base station.

In an embodiment, the PUCCH resource for transmission of the HARQ-ACK is obtained via an index of a Control Channel Element (CCE) of PDCCH or an index of a CCE of EPDCCH when neither of PDCCH/EPDCCH and PDSCH is configured for repetitive transmission; and the PUCCH resource for transmission of the HARQ-ACK is obtained via Radio Resource Control (RRC) signaling when PDCCH/EPDCCH or PDSCH is configured for repetitive transmission.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.

In another aspect of the present disclosure, a base station is provided. The base station comprises: a determining unit configured to determine whether repetitive transmission of a Hybrid Automatic Repeat reQuest (HARQ)-Acknowledgement (ACK) is enabled, and determining whether Physical Downlink Control Channel (PDCCH)/Extended Physical Downlink Control Channel (EPDCCH), or Physical Downlink Shared Channel (PDSCH) is configured for repetitive transmission; and a configuring unit configured to configure for a User Equipment (UE) a Physical Uplink Control Channel (PUCCH) resource for transmission of the HARQ-ACK.

In an embodiment, the configuring unit is configured to, when the repetitive transmission of the HARQ-ACK is enabled: configure for the UE the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and configure for the UE the PUCCH resource for transmission of the HARQ-ACK via Radio Resource Control (RRC) signaling when PDCCH/EPDCCH or PDSCH is configured for repetitive transmission.

In an embodiment, the configuring unit is configured to, when the repetitive transmission of the HARQ-ACK is not enabled and PDCCH/EPDCCH or PDSCH is configured for repetitive transmission, configure for the UE the PUCCH resource for transmission of the HARQ-ACK via Radio Resource Control (RRC) signaling.

In an embodiment, the configuring unit is configured to configure for the UE a set of PUCCH resources via Radio Resource Control (RRC) signaling and PDCCH/EPDCCH indicates over which of the set of PUCCH resources should the UE transmit HARQ-ACK.

In an embodiment, the configuring unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, the configuring unit is configured to, when the UE is in a coverage enhancement mode or an enhancement is desired for a PUCCH transmission of the UE, configure a scheme for repetitive transmission of HARQ-ACK by the UE via RRC signaling or corresponding PDCCH control information.

In an embodiment, the scheme for repetitive transmission of HARQ-ACK by the UE comprises a scheme in PUCCH Format 3.

In another aspect, a base station is provided. The base station comprises: a determining unit configured to determine whether Physical Downlink Control Channel (PDCCH)/Extended Physical Downlink Control Channel (EPDCCH), or Physical Downlink Shared Channel (PDSCH) is configured for repetitive transmission; and a configuring unit configured to configure for a User Equipment (UE) a Physical Uplink Control Channel (PUCCH) resource for transmission of a Hybrid Automatic Repeat reQuest (HARQ)-Acknowledgement (ACK).

In an embodiment, the configuring unit is configured to: configure for the UE the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and configure for the UE the PUCCH resource for transmission of the HARQ-ACK via Radio Resource Control (RRC) signaling when PDCCH/EPDCCH or PDSCH is configured for repetitive transmission.

In an embodiment, the configuring unit is configured to configure for the UE a set of PUCCH resources via Radio Resource Control (RRC) signaling and PDCCH/EPDCCH indicates over which of the set of PUCCH resources should the UE transmit HARQ-ACK.

In an embodiment, the configuring unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, the configuring unit is configured to, when the UE is in a coverage enhancement mode or an enhancement is desired for a PUCCH transmission of the UE, configure a scheme for repetitive transmission of HARQ-ACK by the UE via RRC signaling or corresponding PDCCH control information.

In an embodiment, the scheme for repetitive transmission of HARQ-ACK by the UE comprises a scheme in PUCCH Format 3.

In another aspect of the present disclosure, a User Equipment (UE) is provided. The UE comprises: a determining unit configured to determine whether repetitive transmission of a Hybrid Automatic Repeat reQuest (HARQ)-Acknowledgement (ACK) is enabled, and determine whether Physical Downlink Control Channel (PDCCH)/Extended Physical Downlink Control Channel (EPDCCH), or Physical Downlink Shared Channel (PDSCH) is configured for repetitive transmission; and a transmitting unit configured to transmit the HARQ-ACK over a Physical Uplink Control Channel (PUCCH) resource allocated by a base station.

In an embodiment, the transmitting unit is configured to, when the repetitive transmission of the HARQ-ACK is enabled: obtain the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and obtain the PUCCH resource for transmission of the HARQ-ACK via Radio Resource Control (RRC) signaling when PDCCH/EPDCCH or PDSCH is configured for repetitive transmission.

In an embodiment, the transmitting unit is configured to, when the repetitive transmission of the HARQ-ACK is not enabled and PDCCH/EPDCCH or PDSCH is configured for repetitive transmission, obtain the PUCCH resource for transmission of the HARQ-ACK via Radio Resource Control (RRC) signaling.

In an embodiment, the transmitting unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.

In an aspect of the present disclosure, a User Equipment (UE) is provided. The UE comprises: a determining unit configured to determine whether Physical Downlink Control Channel (PDCCH)/Extended Physical Downlink Control Channel (EPDCCH), or Physical Downlink Shared Channel (PDSCH) is configured for repetitive transmission; and a transmitting unit configured to transmit a Hybrid Automatic Repeat reQuest (HARQ)-Acknowledgement (ACK) over a Physical Uplink Control Channel (PUCCH) resource allocated by a base station.

In an embodiment, the transmitting unit is configured to: obtain the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and obtain the PUCCH resource for transmission of the HARQ-ACK via Radio Resource Control (RRC) signaling when PDCCH/EPDCCH or PDSCH is configured for repetitive transmission.

In an embodiment, the transmitting unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three.

In an embodiment, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.

With the present disclosure, it is possible to improve resource utilization and spectrum/energy efficiency of MTC UEs supported by the LTE and reduce inter-cell time/frequency resource collisions.

### BRIEF DESCRIPTION OF THE DRAWINGS

The above and other objects, features and advantages will be more apparent from the following description of embodiments with reference to the figures, in which:

FIG. 1 is a flowchart illustrating a method performed by a base station according to an embodiment of the present disclosure;

FIG. 2 is a schematic diagram showing a timing sequence of PUCCH and its corresponding PDSCH according to the present disclosure;

FIG. 3 is a schematic diagram showing processing of coded ACK/NACK bits to a physical layer;

FIG. 4 is a flowchart illustrating a method performed by a UE according to an embodiment of the present disclosure;

FIG. 5 is a block diagram of a base station according to an embodiment of the present disclosure;

FIG. 6 is a block diagram of a UE according to an embodiment of the present disclosure;

FIG. 7 is a flowchart illustrating another method performed by a base station according to an embodiment of the present disclosure; and

FIG. 8 is a flowchart illustrating another method performed by a UE according to an embodiment of the present disclosure.

### DETAILED DESCRIPTION

The embodiments of the present disclosure (in particular, a method for transmitting/receiving PDCCH, a base station and a UE for low cost UEs that may or may not require additional coverage enhancement or other UEs that support delay-tolerant MTC services and require a certain amount of coverage enhancement) will be detailed below with reference to the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

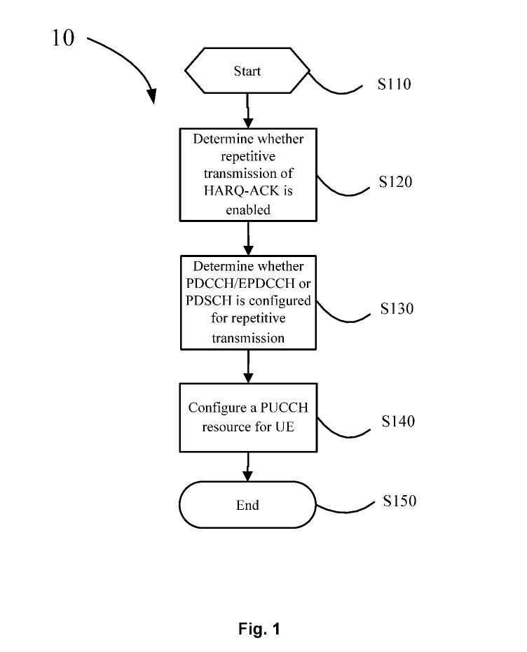

FIG. 1 is a flowchart illustrating a method performed by a base station according to an embodiment of the present disclosure. As shown in FIG. 1, the method 10 starts with step S110.

At step S120, it is determined whether repetitive transmission of a Hybrid Automatic Repeat reQuest (HARQ)-Acknowledgement (ACK) is enabled. For example, the repetitive transmission of the HARQ-ACK may be dependent on a higher layer enabling/disabling UE specific parameter ackNackRepetition. If the repetitive transmission of the HARQ-ACK is enabled, an MTC UE transmits the HARQ-ACK for N_{ANRep} times repetitively, where N_{ANRep} is a repetition parameter configured by a higher layer.

At step S130, it is determined whether (Extended) Physical Downlink Control Channel, ((E)PDCCH), or Physical Downlink Shared Channel (PDSCH) is configured for repetitive transmission.

At step S140, a Physical Uplink Control Channel (PUCCH) resource is configured for a UE for transmission of the HARQ-ACK.

In an embodiment, when the repetitive transmission of the HARQ-ACK is enabled, the PUCCH resource for transmission of the HARQ-ACK is configured for the UE via an index of a Control Channel Element (CCE) of PDCCH or an index of a CCE of EPDCCH when neither of PDCCH/EPDCCH and PDSCH is configured for repetitive transmission. For example, when neither of PDCCH/EPDCCH and a PDSCH indicated by PDCCH/EPDCCH or PDSCH related to downlink SPS release indicated by PDCCH/EPDCCH is configured for repetitive transmission, the UE first transmits one HARQ-ACK feedback over a PUCCH resource obtained implicitly based the corresponding PDCCH CCE index or EPDCCH ECCE index. Then, the HARQ-ACK feedback is transmitted for N_{ANReP}−1 times repetitively over the PUCCH resource n_{PUCCH,ANRep}^{(1,\tilde{p})} configured by a higher layer.

When PDCCH/EPDCCH or PDSCH is configured for repetitive transmission, the PUCCH resource for transmission of the HARQ-ACK is configured for the UE via Radio Resource Control (RRC) signaling. For example, when PDCCH/EPDCCH or a PDSCH indicated by PDCCH/EPDCCH or PDSCH related to downlink SPS release indicated by PDCCH/EPDCCH is configured for repetitive transmission, the UE transmits the HARQ-ACK feedback for N_{ANReP} times successively over the PUCCH resource n_{PUCCH,ANRep}^{(1,\tilde{p})} configured by a higher layer/via RRC signaling.

The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| ackNackRepetition | CHOICE{ |
| release | NULL, |
| setup | SEQUENCE { |
| repetitionFactor | ENUMERATED {n2, n4, n6, n8, ...}, |
| n1PUCCH-AN-Rep | INTEGER (0..2047) |
| } | |
| }, | |
| tdd-AckNackFeedbackMode | ENUMERATED {bundling, multiplexing} OPTIONAL -- |
| Cond TDD | |
| } | |

where the repetitive transmission parameter repetitionFactor indicates N_{ANReP} and should be extended from {n2,n4,n6,spare1} now to {n2,n4,n6,n8, . . . }; and the parameter n1PUCCH-AN-Rep indicates n_{PUCCH,ANRep}^{(1,\tilde{p})}.

In an embodiment, when the repetitive transmission of the HARQ-ACK is not enabled and PDCCH/EPDCCH or PDSCH is configured for repetitive transmission, the PUCCH resource for transmission of the HARQ-ACK is configured for the UE via Radio Resource Control (RRC) signaling. For example, if the repetitive transmission of the HARQ-ACK is not enabled, the UE transmits a HARQ-ACK feedback only once for each received PDSCH. When PDCCH/EPDCCH or a PDSCH indicated by PDCCH/EPDCCH or PDSCH related to downlink SPS release indicated by PDCCH/EPDCCH is configured for repetitive transmission, the UE transmits the HARQ-ACK feedback once over the PUCCH resource n_{PUCCH,ANRep}^{(1,\tilde{p})} configured by a higher layer/via RRC signaling. The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| deltaPUCCH-Shift | ENUMERATED {ds1, ds2, ds3}, |
| nRB-CQI | INTEGER (0..98), |
| nCS-AN | INTEGER (0..7), |
| n1PUCCH-AN-r12 | INTEGER (0..2047) |
| } | |

where the parameter n1PUCCH-AN-r12 indicates n_{PUCCH,ANRep}^{(1,\tilde{p})}.

In an embodiment, a low-cost Machine Type Communication (MTC) service is configured for the UE and, when a PDSCH transmission for the UE occurs in the k-th subframe following the last transmission of a corresponding PDCCH, where k is an integer larger than zero, the PUCCH resource for transmission of the HARQ-ACK is configured for the UE via Radio Resource Control (RRC) signaling. For example, when a PDSCH transmission for the UE occurs in the k-th subframe following the last transmission of a corresponding PDCCH, where k is an integer larger than zero, the UE transmits the HARQ-ACK feedback for N_{ANRep} times successively over the PUCCH resource n_{PUCCH,ANRep}^{(1,\tilde{p})} configured by a higher layer/via RRC signaling.

In an embodiment, a set of PUCCH resources is configured for the UE via Radio Resource Control (RRC) signaling and PDCCH/EPDCCH indicates over which of the set of PUCCH resources should the UE transmit HARQ-ACK. For example, the PUCCH resource can be provided to the UE explicitly. In particular, a set of PUCCH resources n_{PUCCH,ANRep}^{(1,\tilde{p})} can be configured for the UE semi-statically by a higher layer/via RRC signaling. Then, control information in the corresponding PDCCH/EPDCCH can be used to dynamically indicate which of the set of resources is to be used by the UE.

When the repetitive transmission of the HARQ-ACK is not enabled, the UE transmits the HARQ-ACK feedback once over the obtained PUCCH resource n_{PUCCH,ANRep}^{(1,\tilde{p})}. This is explained with reference to a specific example as follows.

If the set of resources configured by a higher layer/via RRC signaling has a size of 4, the control information in PDCCH/EPDCCH for dynamically indicating the PUCCH resource can be provided in the TPC field in the DCI format. Its mapping is shown in Table 1 below. The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| deltaPUCCH-Shift | ENUMERATED {ds1, ds2, ds3}, |
| nRB-CQI | INTEGER (0..98), |
| nCS-AN INTEGER | (0..7), |
| n1PUCCH-AN-r12 | SEQUENCE (SIZE(1...4)) OF INTEGER (0..2047) |
| } | |

TABLE 1
PUCCH Resource Value for HARQ-ACK Resource

| Value of TPC Command for PUCCH | |
|---|---|
| or HARQ-ACK Resource Offset | n_{PUCCH}^{(1, \tilde{p})} |
| ‘00’ | 1^{st} PUCCH resource value |
| | configured by a higher layer |
| ‘01’ | 2^{nd} PUCCH resource value |
| | configured by a higher layer |
| ‘10’ | 3^{rd} PUCCH resource value |
| | configured by a higher layer |
| ‘11’ | 4^{th} PUCCH resource value |
| | configured by a higher layer |

When the repetitive transmission of the HARQ-ACK is enabled, the UE transmits the HARQ-ACK feedback for N_{ANRep} times successively over the obtained PUCCH resource n_{PUCCH,ANRep}^{(1,\tilde{p})}. This is explained with reference to a specific example as follows.

If the set of resources configured by a higher layer/via RRC signaling has a size of 4, the control information in PDCCH/EPDCCH for dynamically indicating the PUCCH resource can be provided in the TPC field in the DCI format. Its mapping is shown in Table 1 above. The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| ackNackRepetition | CHOICE{ |
| release | NULL, |
| setup | SEQUENCE { |
| repetitionFactor | ENUMERATED {n2, n4, n6, n8, ...}, |
| n1PUCCH-AN-Rep-r12 | SEQUENCE (SIZE(1...4) ) OF INTEGER (0..2047) |
| } | |
| }, | |
| tdd-AckNackFeedbackMode | ENUMERATED {bundling, multiplexing} OPTIONAL -- |
| Cond TDD | |
| } | |
| N1PUCCH-AN-RepP1-r12 | EQUENCE (SIZE(1...4)) OF INTEGER (0..2047) OPTIONAL |
| -- Need OR | |

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k can be predetermined, configured semi-statically via RRC signaling, or determined dynamically based on control information in PDCCH/EPDCCH.

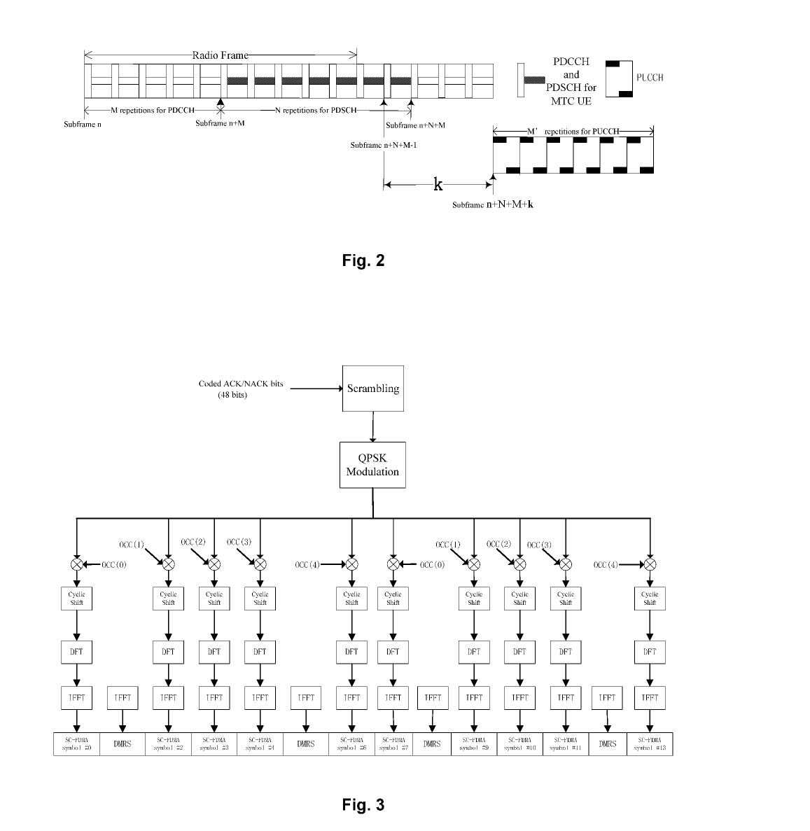

FIG. 2 is a schematic diagram showing a timing sequence of PUCCH and its corresponding PDSCH according to the present disclosure. As shown in FIG. 2, when the n-th subframe is used for transmission of the last repetitive PDSCH, the transmission of PUCCH starts at the (n+k)-th subframe, where k is an integer larger than three. The value of k can be predetermined, configured semi-statically by a higher layer or via RRC signaling, or determined dynamically based on control information in PDCCH/EPDCCH.

In an embodiment, when the UE is in a coverage enhancement mode or an enhancement is desired for a PUCCH transmission of the UE, a scheme for repetitive transmission of HARQ-ACK by the UE is configured via RRC signaling or corresponding (E)PDCCH control information. Preferably, the scheme for repetitive transmission of HARQ-ACK by the UE includes a scheme in PUCCH Format 3.

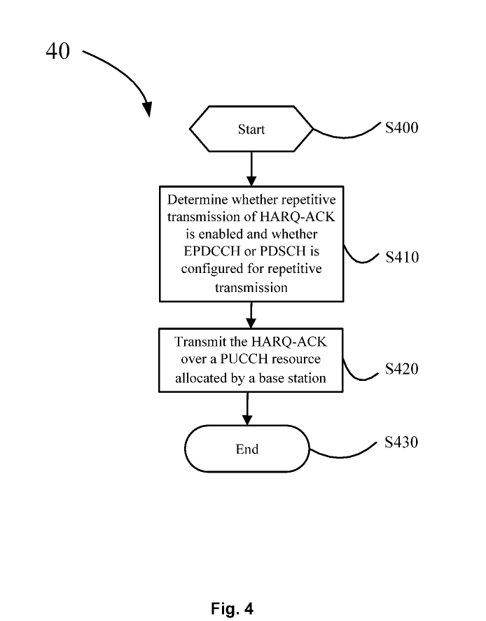

For example, when the repetitive transmission of the HARQ-ACK is enabled and the UE is configured with only one serving cell, the UE can use the PUCCH Format 3 for transmitting HARQ-ACK feedback. Here, the HARQ-ACK bits can be configured in accordance with Section 5.2.3.1 in TS 36.212 and then mapped to the physical layer in the scheme shown in FIG. 3. In particular, as shown in FIG. 3, one ACK/NACK bit and scheduling request bits (if any) are concatenated into a sequence of bits. This sequence is block coded into a 48-bit channel coding, which is then scrambled and QPSK modulated to form 24 modulated symbols. These 24 modulated symbols are divided into two groups each (containing 12 modulated symbols) corresponding to one timeslot. Each group of 12 modulated symbols is cyclically shifted before being inputted to a DFT module, and then IFFT transformed and mapped onto physical resources. In order to increase the multiplexing capacity, the 12 modulated symbols are multiplied with an orthogonal sequence having a length of 5, such that a pair of physical resource blocks can support up to 5 UEs.

Finally, the method 10 ends at step S150.

The method for PUCCH resource configuration according to this embodiment allows the network side (i.e., base station) to explicitly configure the PUCCH resources for the UE and the timing sequence of PUCCH and its corresponding PDSCH. With this embodiment, it is possible to improve resource utilization and spectrum/energy efficiency of MTC UEs supported by the LTE and reduce inter-cell time/frequency resource collisions.

Since the low-complexity MTC UE suffers from an uplink channel performance loss due to single antenna and has a low uplink transmission power, its uplink physical channels need coverage enhancement. Hence, in some scenarios, the coverage enhancement for physical uplink channels of the MTC UE is mandatory.

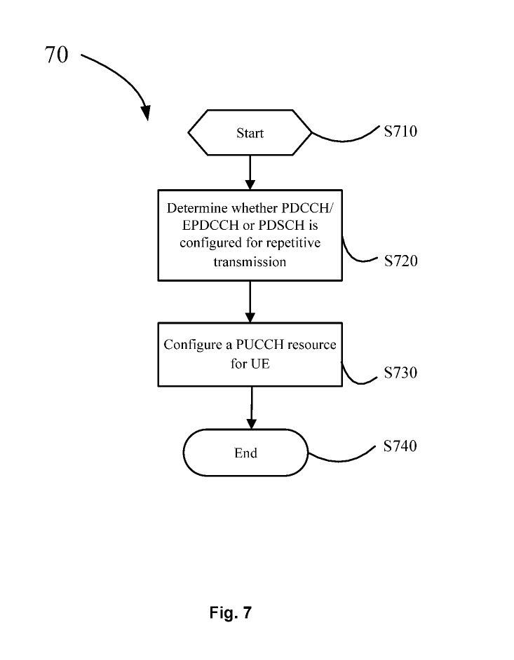

FIG. 7 is a flowchart illustrating another method performed by a base station according to an embodiment of the present disclosure. As shown in FIG. 7, the method 70 starts with step S710.

At step S720, it is determined whether Physical Downlink Control Channel (PDCCH)/Extended Physical Downlink Control Channel (EPDCCH), or Physical Downlink Shared Channel (PDSCH) is configured for repetitive transmission.

At step S730, a Physical Uplink Control Channel (PUCCH) resource for transmission of a Hybrid Automatic Repeat reQuest (HARQ)-Acknowledgement (ACK) is configured for a User Equipment (UE).

In an embodiment, the PUCCH resource for transmission of the HARQ-ACK is configured for the UE via an index of a Control Channel Element (CCE) of PDCCH or an index of a CCE of EPDCCH when neither of PDCCH/EPDCCH and PDSCH is configured for repetitive transmission. For example, when neither of PDCCH/EPDCCH and a PDSCH indicated by PDCCH/EPDCCH or PDSCH related to downlink SPS release indicated by PDCCH/EPDCCH is configured for repetitive transmission, the UE first transmits one HARQ-ACK feedback over a PUCCH resource obtained implicitly based the corresponding PDCCH CCE index or EPDCCH ECCE index. Then, the HARQ-ACK feedback is transmitted for N_{ANRep}−1 times repetitively over the PUCCH resource n_{PUCCH,ANRep}^{(1,\tilde{p})} configured by a higher layer.

When PDCCH/EPDCCH or PDSCH is configured for repetitive transmission, the PUCCH resource for transmission of the HARQ-ACK is configured for the UE via Radio Resource Control (RRC) signaling. For example, when PDCCH/EPDCCH or a PDSCH indicated by PDCCH/EPDCCH or PDSCH related to downlink SPS release indicated by PDCCH/EPDCCH is configured for repetitive transmission, the UE transmits the HARQ-ACK feedback for N_{ANRep} times successively over the PUCCH resource n_{PUCCH,ANRep}^{(1,\tilde{p})} configured by a higher layer/via RRC signaling.

The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| ackNackRepetition | SEQUENCE { |
| repetitionFactor | ENUMERATED {n2, n4, n6, n8, ...}, |
| n1PUCCH-AN-Rep | INTEGER (0..2047) |
| }, | |
| tdd-AckNackFeedbackMode | ENUMERATED {bundling, multiplexing} OPTIONAL -- |
| Cond TDD | |
| } | |

where the repetitive transmission parameter repetitionFactor indicates N_{ANReP} and should be extended from {n2,n4,n6,spare1} now to {n2,n4,n6,n8, . . . }; and the parameter n1PUCCH-AN-Rep indicates n_{PUCCH,ANRep}^{(1,\tilde{p})}.

In an embodiment, a low-cost Machine Type Communication (MTC) service is configured for the UE and, when a PDSCH transmission for the UE occurs in the k-th subframe following the last transmission of a corresponding PDCCH, where k is an integer larger than zero, the PUCCH resource for transmission of the HARQ-ACK is configured for the UE via Radio Resource Control (RRC) signaling. For example, when a PDSCH transmission for the UE occurs in the k-th subframe following the last transmission of a corresponding PDCCH, where k is an integer larger than zero, the UE transmits the HARQ-ACK feedback for N_{ANRep} times successively over the PUCCH resource n_{PUCCH,ANRep}^{(1,\tilde{p})} configured by a higher layer/via RRC signaling.

In an embodiment, a set of PUCCH resources is configured for the UE via Radio Resource Control (RRC) signaling and PDCCH/EPDCCH indicates over which of the set of PUCCH resources should the UE transmit HARQ-ACK. For example, the PUCCH resource (can be provided to the UE explicitly. In particular, a set of PUCCH resources n_{PUCCH,ANRep}^{(1,\tilde{p})} can be configured for the UE semi-statically by a higher layer/via RRC signaling. Then, control information in the corresponding PDCCH/EPDCCH can be used to dynamically indicate which of the set of resources is to be used by the UE.

The UE transmits the HARQ-ACK feedback for N_{ANReP} times successively over the obtained PUCCH resource n_{PUCCH,ANRep}^{(1,\tilde{p})}. This is explained with reference to a specific example as follows.

If the set of resources configured by a higher layer/via RRC signaling has a size of 4, the control information in PDCCH/EPDCCH for dynamically indicating the PUCCH resource can be provided in the TPC field in the DCI format. Its mapping is shown in Table 1 above. The associated higher layer configuration/RRC signaling can be provided in the Information Element (IE) PUCCH-ConfigDedicated, as follows:

| | |
|---|---|
| PUCCH-ConfigDedicated-v12 ::= | SEQUENCE { |
| ackNackRepetition | CHOICE { |
| release | NULL, |
| setup | SEQUENCE { |
| repetitionFactor | ENUMERATED {n2, n4, n6, n8, ...}, |
| n1PUCCH-AN-Rep-r12 | SEQUENCE (SIZE(1...4) ) OF INTEGER (0..2047) |
| } | |
| }, | |
| tdd-AckNackFeedbackMode | ENUMERATED {bundling, multiplexing} OPTIONAL -- |
| Cond TDD | |
| } | |
| N1PUCCH-AN-RepP1-r12 | EQUENCE (SIZE{1...4)) OF INTEGER (0..2047) OPTIONAL |
| -- Need OR | |

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k can be predetermined, configured semi-statically via RRC signaling, or determined dynamically based on control information in PDCCH/EPDCCH.

Referring back to FIG. 2, which is a schematic diagram showing a timing sequence of PUCCH and its corresponding PDSCH according to the present disclosure, as shown, when the n-th subframe is used for transmission of the last repetitive PDSCH, the transmission of PUCCH starts at the (n+k)-th subframe, where k is an integer larger than three. The value of k can be predetermined, configured semi-statically by a higher layer or via RRC signaling, or determined dynamically based on control information in PDCCH/EPDCCH.

In an embodiment, when the UE is in a coverage enhancement mode or an enhancement is desired for a PUCCH transmission of the UE, a scheme for repetitive transmission of HARQ-ACK by the UE is configured via RRC signaling or corresponding (E)PDCCH control information. Preferably, the scheme for repetitive transmission of HARQ-ACK by the UE includes a scheme in PUCCH Format 3.

For example, when the repetitive transmission of the HARQ-ACK is enabled and the UE is configured with only one serving cell, the UE can use the PUCCH Format 3 for transmitting HARQ-ACK feedback. Here, the HARQ-ACK bits can be configured in accordance with Section 5.2.3.1 in TS 36.212 and then mapped to the physical layer in the scheme shown in FIG. 3. In particular, as shown in FIG. 3, one ACK/NACK bit and scheduling request bits (if any) are concatenated into a sequence of bits. This sequence is block coded into a 48-bit channel coding, which is then scrambled and QPSK modulated to form 24 modulated symbols. These 24 modulated symbols are divided into two groups each (containing 12 modulated symbols) corresponding to one timeslot. Each group of 12 modulated symbols is cyclically shifted before being inputted to a DFT module, and then IFFT transformed and mapped onto physical resources. In order to increase the multiplexing capacity, the 12 modulated symbols are multiplied with an orthogonal sequence having a length of 5, such that a pair of physical resource blocks can support up to 5 UEs.

Finally, the method 70 ends at step S740.

FIG. 4 is a flowchart illustrating a method performed by a UE according to an embodiment of the present disclosure. As shown in FIG. 4, the method 40 starts with step S400.

At step S410, it is determined whether repetitive transmission of a Hybrid Automatic Repeat reQuest (HARQ)-Acknowledgement (ACK) is enabled and whether Physical Downlink Control Channel (PDCCH)/Extended Physical Downlink Control Channel (EPDCCH), or Physical Downlink Shared Channel (PDSCH) is configured for repetitive transmission.

At step S420, the HARQ-ACK is transmitted over a Physical Uplink Control Channel (PUCCH) resource allocated by a base station.

In an embodiment, when the repetitive transmission of the HARQ-ACK is enabled: the PUCCH resource for the first transmission of the HARQ-ACK is obtained via an index of a Control Channel Element (CCE)/ECCE of PDCCH/EPDCCH and the PUCCH resource for the remaining N_{ANRep}−1 transmissions of the HARQ-ACK is obtained via Radio Resource Control (RRC) signaling when neither of PDCCH/EPDCCH and PDSCH is configured for repetitive transmission; and the PUCCH resource for transmission of the HARQ-ACK is obtained via Radio Resource Control (RRC) signaling when PDCCH/EPDCCH or PDSCH is configured for repetitive transmission.

In an embodiment, when the repetitive transmission of the HARQ-ACK is not enabled and PDCCH/EPDCCH or PDSCH is configured for repetitive transmission, the PUCCH resource for transmission of the HARQ-ACK is obtained via Radio Resource Control (RRC) signaling.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k is predetermined, configured semi-statically via RRC signaling, or determined dynamically based on control information in PDCCH/EPDCCH.

Preferably, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information. For example, the scheme for repetitive transmission of HARQ-ACK by the UE includes a scheme in PUCCH Format 3.

Finally, the method 40 ends at step S430.

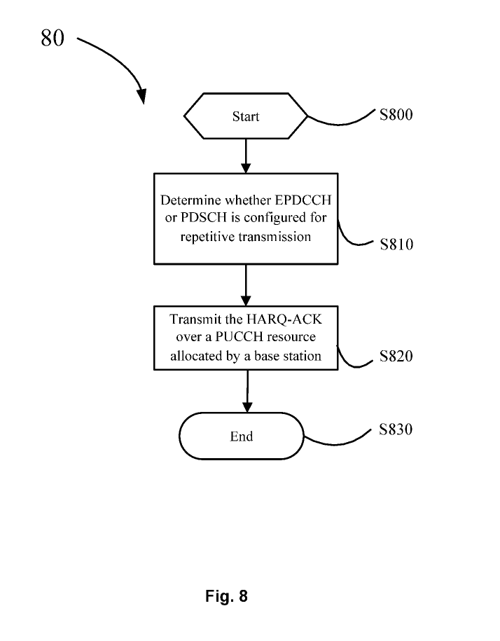

FIG. 8 is a flowchart illustrating another method performed by a UE according to an embodiment of the present disclosure. As shown in FIG. 8, the method 80 starts with step S800.

At step S810, it is determined whether Physical Downlink Control Channel (PDCCH)/Extended Physical Downlink Control Channel (EPDCCH), or Physical Downlink Shared Channel (PDSCH) is configured for repetitive transmission.

At step S820, a Hybrid Automatic Repeat reQuest (HARQ)-Acknowledgement (ACK) is transmitted over a Physical Uplink Control Channel (PUCCH) resource allocated by a base station.

In an embodiment, the PUCCH resource for the first transmission of the HARQ-ACK is obtained via an index of a Control Channel Element (CCE)/ECCE of PDCCH/EPDCCH and the PUCCH resource for the remaining N_{ANRep}−1 transmissions of the HARQ-ACK is obtained via Radio Resource Control (RRC) signaling when neither of PDCCH/EPDCCH and PDSCH is configured for repetitive transmission; and the PUCCH resource for transmission of the HARQ-ACK is obtained via Radio Resource Control (RRC) signaling when PDCCH/EPDCCH or PDSCH is configured for repetitive transmission.

In an embodiment, when PDCCH/EPDCCH or PDSCH is configured for repetitive transmission, the PUCCH resource for transmission of the HARQ-ACK is obtained via Radio Resource Control (RRC) signaling.

In an embodiment, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k is predetermined, configured semi-statically via RRC signaling, or determined dynamically based on control information in PDCCH/EPDCCH.

Preferably, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information. For example, the scheme for repetitive transmission of HARQ-ACK by the UE includes a scheme in PUCCH Format 3.

Finally, the method 80 ends at step S830.

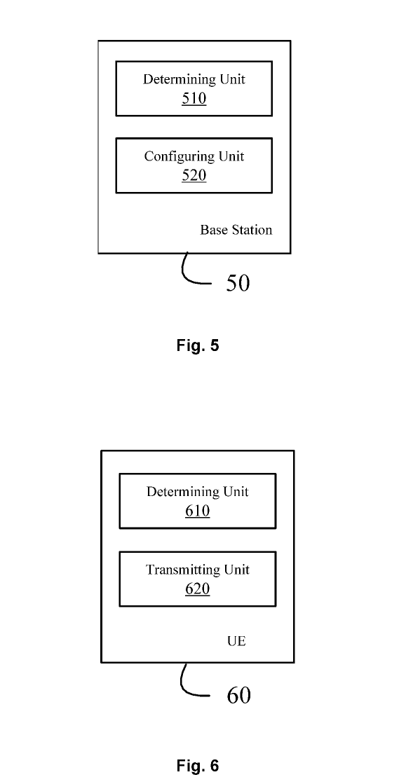

FIG. 5 is a block diagram of a base station according to an embodiment of the present disclosure. As shown in FIG. 5, the base station 50 includes a determining unit 510 and a configuring unit 520.

The determining unit 510 is configured to determine whether repetitive transmission of a Hybrid Automatic Repeat reQuest (HARQ)-Acknowledgement (ACK) is enabled, and determining whether Physical Downlink Control Channel (PDCCH)/Extended Physical Downlink Control Channel (EPDCCH), or Physical Downlink Shared Channel (PDSCH) is configured for repetitive transmission. Alternatively, the determining unit 510 can be configured to determine whether Physical Downlink Control Channel (PDCCH)/Extended Physical Downlink Control Channel (EPDCCH), or Physical Downlink Shared Channel (PDSCH) is configured for repetitive transmission.

The configuring unit 520 is configured to configure for a User Equipment (UE) a Physical Uplink Control Channel (PUCCH) resource for transmission of a Hybrid Automatic Repeat reQuest (HARQ)-Acknowledgement (ACK).

In an embodiment, the configuring unit 520 is configured to, when the repetitive transmission of the HARQ-ACK is enabled: configure for the UE the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and configure for the UE the PUCCH resource for transmission of the HARQ-ACK via Radio Resource Control (RRC) signaling when PDCCH/EPDCCH or PDSCH is configured for repetitive transmission.

In an embodiment, the repetitive transmission of the HARQ-ACK is enabled mandatorily without configuration via higher layer signaling. In this case, the configuring unit 520 is configured to: configure for the UE the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and configure for the UE the PUCCH resource for transmission of the HARQ-ACK via Radio Resource Control (RRC) signaling when PDCCH/EPDCCH or PDSCH is configured for repetitive transmission.

In an embodiment, the configuring unit 520 is configured to, when the repetitive transmission of the HARQ-ACK is not enabled and PDCCH/EPDCCH or PDSCH is configured for repetitive transmission, configure for the UE the PUCCH resource for transmission of the HARQ-ACK via Radio Resource Control (RRC) signaling.

In an embodiment, the configuring unit 520 is configured to, when a low-cost Machine Type Communication (MTC) service is configured for the UE and when a PDSCH transmission for the UE occurs in the k-th subframe following the last transmission of a corresponding PDCCH, where k is an integer larger than zero, configure for the UE the PUCCH resource for transmission of the HARQ-ACK via Radio Resource Control (RRC) signaling. For example, when a PDSCH transmission for the UE occurs in the k-th subframe following the last transmission of a corresponding PDCCH, where k is an integer larger than zero, the UE transmits the HARQ-ACK feedback for N_{ANRep} times successively over the PUCCH resource n_{PUCCH,ANRep}^{(1,\tilde{p})} configured by a higher layer/via RRC signaling.

In an embodiment, the configuring unit 520 is configured to configure for the UE a set of PUCCH resources via Radio Resource Control (RRC) signaling and PDCCH/EPDCCH indicates over which of the set of PUCCH resources should the UE transmit HARQ-ACK.

In an embodiment, the configuring unit 520 is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k is predetermined, configured semi-statically via RRC signaling, or determined dynamically based on control information in PDCCH/EPDCCH.

In an embodiment, the configuring unit 520 is configured to, when the UE is in a coverage enhancement mode or an enhancement is desired for a PUCCH transmission of the UE, configure a scheme for repetitive transmission of HARQ-ACK by the UE via RRC signaling or corresponding PDCCH control information. Preferably, the scheme for repetitive transmission of HARQ-ACK by the UE includes a scheme in PUCCH Format 3.

FIG. 6 is a block diagram of a UE according to an embodiment of the present disclosure. As shown in FIG. 6, the UE 60 includes a determining unit 610 and a transmitting unit 620.

The determining unit 610 is configured to determine whether repetitive transmission of a Hybrid Automatic Repeat reQuest (HARQ)-Acknowledgement (ACK) is enabled, and determine whether Physical Downlink Control Channel (PDCCH)/Extended Physical Downlink Control Channel (EPDCCH), or Physical Downlink Shared Channel (PDSCH) is configured for repetitive transmission.

Alternatively, the determining unit 610 is configured to determine whether Physical Downlink Control Channel (PDCCH)/Extended Physical Downlink Control Channel (EPDCCH), or Physical Downlink Shared Channel (PDSCH) is configured for repetitive transmission.

The transmitting unit 620 is configured to transmit the HARQ-ACK over a Physical Uplink Control Channel (PUCCH) resource allocated by a base station.

In an embodiment, the transmitting unit 620 is configured to, when the repetitive transmission of the HARQ-ACK is enabled: obtain the PUCCH resource for the first transmission of the HARQ-ACK via an index of a Control Channel Element (CCE) of PDCCH or an index of an ECCE of EPDCCH and the PUCCH resource for the remaining N_{ANRep}−1 transmissions of the HARQ-ACK via Radio Resource Control (RRC) signaling when neither of PDCCH/EPDCCH and PDSCH is configured for repetitive transmission; and obtain the PUCCH resource for transmission of the HARQ-ACK via Radio Resource Control (RRC) signaling when PDCCH/EPDCCH or PDSCH is configured for repetitive transmission.

In an embodiment, the repetitive transmission of the HARQ-ACK is enabled mandatorily and the transmitting unit 620 is configured to: obtain the PUCCH resource for the first transmission of the HARQ-ACK via an index of a Control Channel Element (CCE) of PDCCH or an index of an ECCE of EPDCCH and the PUCCH resource for the remaining N_{ANRep}−1 transmissions of the HARQ-ACK via Radio Resource Control (RRC) signaling when neither of PDCCH/EPDCCH and PDSCH is configured for repetitive transmission; and obtain the PUCCH resource for transmission of the HARQ-ACK via Radio Resource Control (RRC) signaling when PDCCH/EPDCCH or PDSCH is configured for repetitive transmission.

In an embodiment, the transmitting unit 620 is configured to, when the repetitive transmission of the HARQ-ACK is not enabled and PDCCH/EPDCCH or PDSCH is configured for repetitive transmission, obtain the PUCCH resource for transmission of the HARQ-ACK via Radio Resource Control (RRC) signaling. In an embodiment, the transmitting unit 620 is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three. Preferably, the value of k is predetermined, configured semi-statically via RRC signaling, or determined dynamically based on control information in PDCCH/EPDCCH.

In an embodiment, when the UE is in a coverage enhancement mode or an enhancement is desired for a PUCCH transmission of the UE, the transmitting unit 620 transmits the HARQ-ACK in accordance with a scheme for repetitive transmission of HARQ-ACK by the UE that is configured via RRC signaling or corresponding control information in PDCCH.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” means a mobile communication data and control exchange center with a large transmit power and a wide coverage area and including functions such as resource allocation/scheduling, data reception/transmission and the like. The term “user equipment” means a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1. (canceled)

2. (canceled)

3. (canceled)

4. (canceled)

5. (canceled)

6. (canceled)

7. (canceled)

8. (canceled)

9. (canceled)

10. A method performed by a base station, comprising:
determining whether Physical Downlink Control Channel (PDCCH)/Extended Physical Downlink Control Channel (EPDCCH), or Physical Downlink Shared Channel (PDSCH) is configured for repetitive transmission; and
configuring for a User Equipment (UE) a Physical Uplink Control Channel (PUCCH) resource for transmission of a Hybrid Automatic Repeat reQuest (HARQ)-Acknowledgement (ACK).

11. The method of claim 10, wherein
the PUCCH resource for transmission of the HARQ-ACK is configured for the UE via an index of a Control Channel Element (CCE) of PDCCH or an index of a CCE of EPDCCH when neither of PDCCH/EPDCCH and PDSCH is configured for repetitive transmission; and
the PUCCH resource for transmission of the HARQ-ACK is configured for the UE via Radio Resource Control (RRC) signaling when PDCCH/EPDCCH or PDSCH is configured for repetitive transmission.

12. The method of claim 10, wherein a set of PUCCH resources is configured for the UE via Radio Resource Control (RRC) signaling and PDCCH/EPDCCH indicates over which of the set of PUCCH resources should the UE transmit HARQ-ACK.

13. (canceled)

14. The method of claim 10, wherein, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three; and the value of k is predetermined, configured semi-statically via RRC signaling, or determined dynamically based on control information in PDCCH/EPDCCH.

15. (canceled)

16. The method of claim 10, wherein, when the UE is in a coverage enhancement mode or an enhancement is desired for a PUCCH transmission of the UE, a scheme for repetitive transmission of HARQ-ACK by the UE is configured via RRC signaling or corresponding PDCCH control information.

17. The method of claim 16, wherein the scheme for repetitive transmission of HARQ-ACK by the UE comprises a scheme in PUCCH Format 3.

18. (canceled)

19. (canceled)

20. (canceled)

21. (canceled)

22. (canceled)

23. (canceled)

24. A method performed by a User Equipment (UE), comprising:
determining whether Physical Downlink Control Channel (PDCCH)/Extended Physical Downlink Control Channel (EPDCCH), or Physical Downlink Shared Channel (PDSCH) is configured for repetitive transmission; and
transmitting a Hybrid Automatic Repeat reQuest (HARQ)-Acknowledgement (ACK) over a Physical Uplink Control Channel (PUCCH) resource allocated by a base station.

25. The method of claim 24, wherein
the PUCCH resource for transmission of the HARQ-ACK is obtained via an index of a Control Channel Element (CCE) of PDCCH or an index of a CCE of EPDCCH when neither of PDCCH/EPDCCH and PDSCH is configured for repetitive transmission; and
the PUCCH resource for transmission of the HARQ-ACK is obtained via Radio Resource Control (RRC) signaling when PDCCH/EPDCCH or PDSCH is configured for repetitive transmission.

26. The method of claim 24, wherein, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three; and the value of k is predetermined, configured semi-statically via RRC signaling, or determined dynamically based on control information in PDCCH/EPDCCH.

27. (canceled)

28. The method of claim 24, wherein, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.

29. (canceled)

30. (canceled)

31. (canceled)

32. (canceled)

33. (canceled)

34. (canceled)

35. (canceled)

36. (canceled)

37. (canceled)

38. A base station, comprising:
a determining unit configured to determine whether Physical Downlink Control Channel (PDCCH)/Extended Physical Downlink Control Channel (EPDCCH), or Physical Downlink Shared Channel (PDSCH) is configured for repetitive transmission; and
a configuring unit configured to configure for a User Equipment (UE) a Physical Uplink Control Channel (PUCCH) resource for transmission of a Hybrid Automatic Repeat reQuest (HARQ)-Acknowledgement (ACK).

39. The base station of claim 38, wherein the configuring unit is configured to:
configure for the UE the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and
configure for the UE the PUCCH resource for transmission of the HARQ-ACK via Radio Resource Control (RRC) signaling when PDCCH/EPDCCH or PDSCH is configured for repetitive transmission.

40. (canceled)

41. The base station of claim 38, wherein the configuring unit is configured to configure for the UE a set of PUCCH resources via Radio Resource Control (RRC) signaling and PDCCH/EPDCCH indicates over which of the set of PUCCH resources should the UE transmit HARQ-ACK.

42. The base station of claim 38, wherein the configuring unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three; and the value of k is predetermined, configured semi-statically via RRC signaling, or determined dynamically based on control information in PDCCH/EPDCCH.

43. (canceled)

44. The base station of claim 38, wherein the configuring unit is configured to, when the UE is in a coverage enhancement mode or an enhancement is desired for a PUCCH transmission of the UE, configure a scheme for repetitive transmission of HARQ-ACK by the UE via RRC signaling or corresponding PDCCH control information.

45. The base station of claim 38, wherein the scheme for repetitive transmission of HARQ-ACK by the UE comprises a scheme in PUCCH Format 3.

46. (canceled)

47. (canceled)

48. (canceled)

49. (canceled)

50. (canceled)

51. (canceled)

52. A User Equipment (UE), comprising:
a determining unit configured to determine whether Physical Downlink Control Channel (PDCCH)/Extended Physical Downlink Control Channel (EPDCCH), or Physical Downlink Shared Channel (PDSCH) is configured for repetitive transmission; and
a transmitting unit configured to transmit a Hybrid Automatic Repeat reQuest (HARQ)-Acknowledgement (ACK) over a Physical Uplink Control Channel (PUCCH) resource allocated by a base station.

53. The UE of claim 52, wherein the transmitting unit is configured to:
obtain the PUCCH resource for transmission of the HARQ-ACK via an index of a Control Channel Element (CCE) of PDCCH or an index of a CCE of EPDCCH when neither of PDCCH/EPDCCH and PDSCH is configured for repetitive transmission; and
obtain the PUCCH resource for transmission of the HARQ-ACK via Radio Resource Control (RRC) signaling when PDCCH/EPDCCH or PDSCH is configured for repetitive transmission.

54. The UE of claim 52, wherein the transmitting unit is configured such that, when the UE is in a coverage enhancement mode or a PDSCH for the UE is configured for repetitive transmission, a PUCCH transmission of the UE occurs in the k-th subframe following the last transmission of a corresponding PDSCH, where k is an integer larger than three; and the value of k is predetermined, configured semi-statically via RRC signaling, or determined dynamically based on control information in PDCCH/EPDCCH.

55. (canceled)

56. The UE of claim 52, wherein, when the UE is in a coverage enhancement mode or an enhancement is desired for a PUCCH transmission of the UE, the HARQ-ACK is transmitted in accordance with a scheme for repetitive transmission of HARQ-ACK by the UE that is configured via RRC signaling or corresponding PDCCH control information.
